(19) United States
(12) Patent Application Publication
(10) Pub. No.: US 2009/0232543 A1
(43) Pub. Date: Sep. 17, 2009

(54) DEVELOPING DEVICE OF IMAGE FORMING APPARATUS

(75) Inventors: Shingo Urasawa, Shizuoka (JP); Mitsutoshi Watanabe, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/401,710

(22) Filed: Mar. 11, 2009

Related U.S. Application Data
(60) Provisional application No. 61/036,570, filed on Mar. 14, 2008.

(51) Int. Cl. G03G 21/18; G03G 15/08; G03G 15/09

(52) U.S. Cl. 399/113; 399/265; 399/277

(57) ABSTRACT

An embodiment of the invention provides a magnet facing between a first separating magnetic pole and a second separating magnetic pole on an outer wall of a case. By the rotation of a developing sleeve, a blocking brush is formed between an inner wall of a supply part and the developing sleeve, and an air entering the case is prevented from entering a carrying part.

### CROSS-REFERENCE TO RELATED APPLICATION

This application is based upon and claims the benefit of priority from provisional U.S. Application 61/036,570 filed on Mar. 14, 2008, the entire contents of which are incorporated herein by reference.

### TECHNICAL FIELD

The present invention relates to a developing device for development using a dry developer used in an image forming apparatus such as a copier and printer.

### BACKGROUND

As a developing device used in an image forming apparatus such as a copier and printer, there is a device for development using a dry developer. In the developing device using a dry developer, an air flow is generated through the developing operation in a direction in which air is taken into the developing device. When the pressure within the developing device increases due to the air flow, the air flow is ejected to the outside from a clearance gap of the developing device. The developer flies to the outside with the air flow ejected to the outside and contaminates surroundings of the developing device.

In order to prevent the increase in pressure within the developing device, a depressurizing hole is provided near the development position of a development container in some devices. The depressurizing hole allows the air taken from the clearance gap at the development position to escape to prevent the air to flow into the development container. A filter for collecting suspended toner is attached to the depressurizing hole to prevent the developer from flying to the outside.

When the depressurizing hole is provided near the opening of the development container, it is difficult to completely remove the air taken into the developing device from the depressurizing hole. Even if the depressurizing hole is provided, the developer may fly to the outside and contaminate the surroundings.

Development of a developing device that can prevent the developer from flying to the outside and prevent contamination due to the developer, even if the pressure within the developing device increases through the developing operation and the air flow is ejected from the clearance gap of the developing device to the outside, is desired.

### SUMMARY

An aspect of the present invention is to prevent a developer from flying to the outside with developing operation and prevent contamination of surroundings of a developing device.

According to an embodiment, a developing device includes a development container having a carrying part that carries a developer and a supply part that supplies the developer to an image carrier, a developing roller that is located in the supply part and carries the developer to an opening part of the supply part, and a block part that is provided between the developing member and the development container at the downstream of the opening part in a rotational direction of the developing roller, and blocks an air flow from the supply part into the carrying part.

### DESCRIPTION OF THE DRAWINGS

FIG. 1 is an overall configuration diagram showing an image forming apparatus of an embodiment;

FIG. 2 is a schematic configuration diagram showing a process cartridge of the embodiment;

FIG. 3 is a schematic configuration diagram showing a developing device of the embodiment; and

FIG. 4 is a diagram for explanation of lines of magnetic force of a magnet roller of the embodiment.

### DETAILED DESCRIPTION

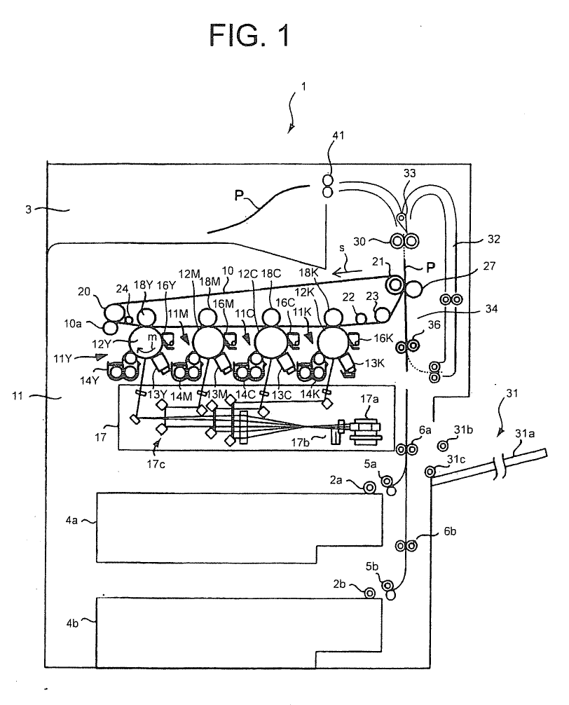

Hereinafter, an embodiment will be described. FIG. 1 is a schematic configuration diagram of a color printer 1 as an image forming apparatus of the embodiment. The color printer 1 is four tandem system. The color printer 1 has a paper discharge part 3 in the upper part.

The color printer 1 has four sets of image forming stations 11Y, 11M, 11C and 11K arranged in a line along the lower side of an intermediate transfer belt 10. The image forming stations 11Y, 11M, 11C and 11K have photoconductive drums 12Y, 12M, 12C and 12K as image carriers, respectively. The respective image forming stations 11Y, 11M, 11C and 11K form toner images of yellow (Y), magenta (M), cyan (C), black (K) on the respective photoconductive drums 12Y, 12M, 12C and 12K.

The respective photoconductive drums 12Y, 12M, 12C and 12K rotate in a direction of an arrow m. Charging chargers 13Y, 13M, 13C and 13K, developing devices 14Y, 14M, 14C and 14K, photoconductor cleaners 16Y, 16M, 16C and 16K are provided around the respective photoconductive drums 12Y, 12M, 12C and 12K along the rotational direction, respectively.

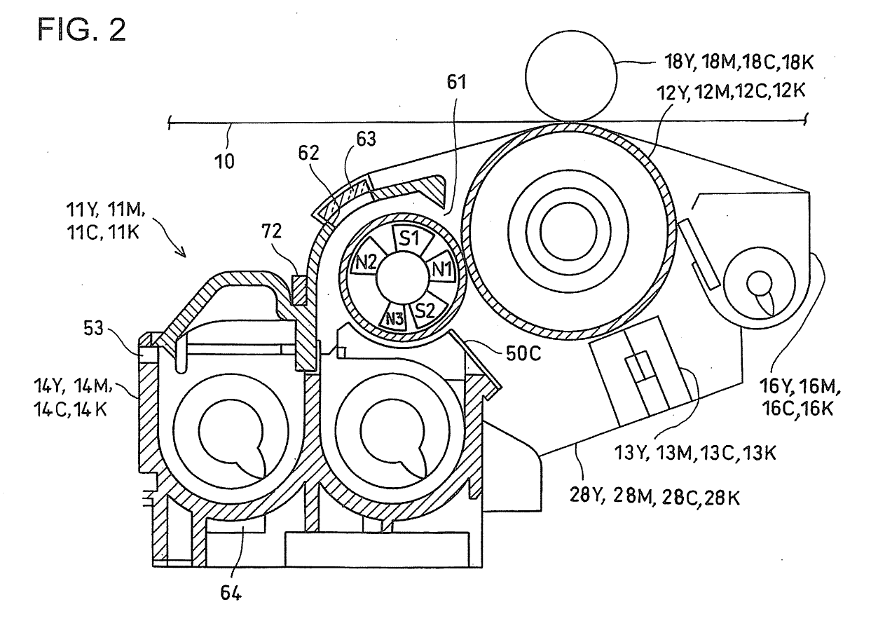

As shown in FIG. 2, for each of the image forming stations 11Y, 11M, 11C and 11K, process cartridges 28Y, 28M, 28C and 28K are formed by integrating the respective photoconductive drums 12Y, 12M, 12C and 12K, charging chargers 13Y, 13M, 13C and 13K, developing devices 14Y, 14M, 14C and 14K, photoconductor cleaners 16Y, 16M, 16C and 16K. The respective process cartridges 28Y, 28M, 28C and 28K are independently and integrally attached to and detached from a main body of the color printer 1, respectively. The configuration of the process cartridge is not limited to the above configuration as long as at least the photoconductor drum and the developing device are integrated.

Respective exposure lights by a laser exposure device 17 is applied to parts from the charging chargers 13Y, 13M, 13C and 13K to the developing devices 14Y, 14M, 14C and 14K around the photoconductive drums 12Y, 12M, 12C and 12K, respectively. The laser exposure device 17 has a polygon mirror 17a, an imaging lens system 17b, a reflecting mirror 17c, etc. The laser exposure device 17 scans a laser beam output from a semiconductor laser device in an axis direction of the photoconductive drums 12Y, 12M, 12C and 12K. Electrostatic latent images are formed on the respective photoconductive drums 12Y, 12M, 12C and 12K by the application of the exposure light from the laser exposure device 17. The respective charging chargers 13Y, 13M, 13C and 13K and the laser exposure device 17 form a latent image forming part.

The respective developing devices 14Y, 14M, 14C and 14K develop the electrostatic latent images on the photoconductive drums 12Y, 12M, 12C and 12K. The respective developing devices 14Y, 14M, 14C and 14K perform development using two-component developers having the respective toner of yellow (Y), magenta (M), cyan (C), black (K) and carrier.

The intermediate transfer belt 10 is hung around a backup roller 21, a driven roller 20 and first to third tension rollers 22-24 and rotated in a direction of an arrow s. The intermediate transfer belt 10 faces in contact with the photoconductive drums 12Y, 12M, 12C and 12K. Primary transfer rollers 18Y, 18M, 18C and 18K are provided in positions of the intermediate transfer belt 10 facing the photoconductive drums 12Y, 12M, 12C and 12K. The respective primary transfer rollers 18Y, 18M, 18C and 18K primarily transfer the toner images formed on the photoconductive drums 12Y, 12M, 12C and 12K onto the intermediate transfer belt 10. The respective photoconductor cleaners 16Y, 16M, 16C and 16K remove and collect the residual toner on the respective photoconductive drums 12Y, 12M, 12C and 12K after primary transfer.

A secondary transfer roller 27 is allowed to face a secondary transfer part of the intermediate transfer belt 10 supported by the backup roller 21. At the secondary transfer part, a predetermined secondary transfer bias is applied to the backup roller 21. After a sheet P passes between the intermediate transfer belt 10 and the secondary transfer roller 27, the toner images on the intermediate transfer belt 10 are secondarily transferred onto the sheet P. The sheet P is fed from paper feed cassettes 4a, 4b or a manual feed mechanism 31. After the secondary transfer has been finished, the intermediate transfer belt 10 is cleaned by a belt cleaner 10a.

Pickup rollers 2a, 2b, separating rollers 5a, 5b, transport rollers 6a, 6b and a pair of resist rollers 36 are provided in a part from the paper feed cassettes 4a, 4b to the secondary transfer roller 27. A manual feed pickup roller 31b and a manual feed separating roller 31c are provided in a part from a manual feed tray 31a of the manual feed mechanism 31 to the pair of resist rollers 36. Along a longitudinal transport path 34, a fixing device 30 is provided at the downstream of the secondary transfer part. The fixing device 30 fixes the toner images transferred onto the sheet P in the secondary transfer part on the sheet P. At the downstream of the fixing device 30, a gate 33 that distributes the sheet P in a direction toward a paper discharge roller 41 or a direction toward a retransport unit 32 is provided. The sheet P guided to the paper discharge roller 41 is discharged to the paper discharge part 3. The sheet P guided to the retransport unit 32 is guided toward the secondary transfer roller 27 again.

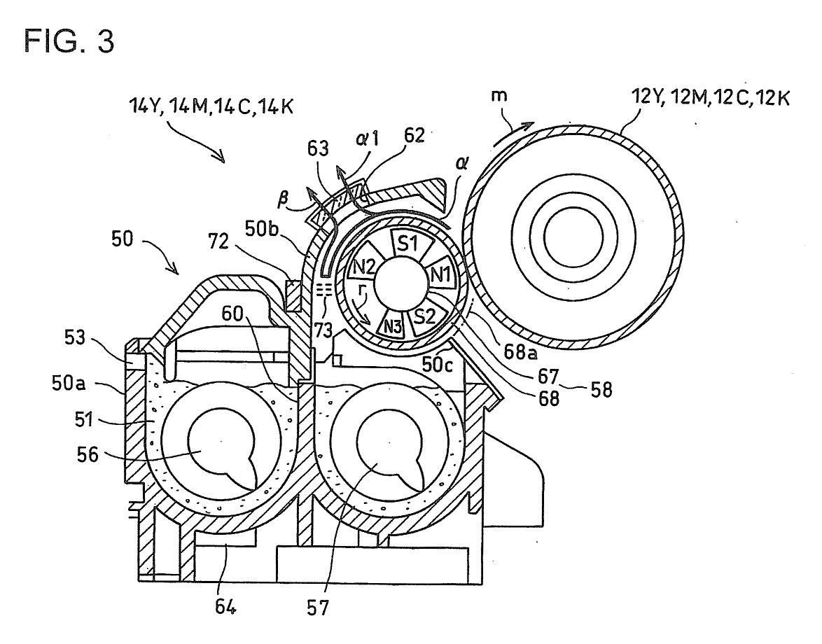

Next, the developing devices 14Y, 14M, 14C and 14K will be described in detail. Since the developing devices 14Y, 14M, 14C and 14K have the same structure, they will be described using common reference numerals and signs. As shown in FIG. 3, each of the developing devices 14Y, 14M, 14C and 14K has a case 50 as a development container made of a resin or the like for containing a developer 51, a stirring mixer 56 and a carrying mixer 57, a developing roller 58 as a developing member, and a toner concentration sensor 64.

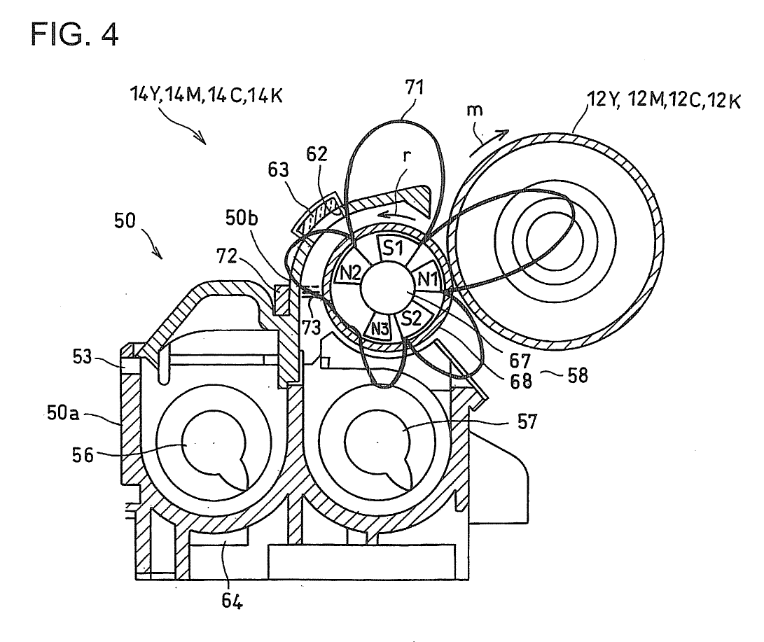

The developing roller 58 has a cylindrical developing sleeve 67 made of a non-magnetic material such as aluminum, stainless, or conductive resin. The developing sleeve 67 rotates in a direction of an arrow r. The developing roller 58 has a magnet roller 68 fixed inside the developing sleeve 67. The magnet roller 68 has a developing magnetic pole N1 of a North pole and a collecting magnetic pole S1 of a South pole. The magnet roller 68 has a first separating magnetic pole N2 of the North pole as a first magnetic pole, a second separating magnetic pole N3 of the North pole as a second magnetic pole and a supply magnetic pole S2 of the South pole. The magnet roller 68 forms lines of magnetic force 71 shown in FIG. 4 by the developing magnetic pole N1, the collecting magnetic pole S1, the first separating magnetic pole N2, the second separating magnetic pole N3 and the supply magnetic pole S2.

The case 50 has a carrying part 50a that supports the stirring mixer 56 and the transport mixer 57 and a supply part 50b that supports the developing roller 58. In the carrying part 50a, the stirring mixer 56 and the transport mixer 57 are partitioned by a partitioning plate 60. The stirring mixer 56 and the transport mixer 57 circulate and carry the developer 51 within the carrying part 50a.

At the bottom of the carrying part 50a, the toner concentration sensor 64 is provided. As the toner concentration sensor 64, for example, a magnetic permeability sensor is used. When the reduction in toner concentration of the developer 51 within the case 50 is detected from the detection result of the toner concentration sensor 64, toner is supplied to the case 50 from the toner cartridge, for example, according to the detection result. Thereby, the toner concentration of the developer 51 within the case 50 is maintained constant.

New carrier is supplied to the carrying part 50a from a carrier cartridge, for example. In supply of the new carrier, only carrier may be supplied. Alternatively, the new carrier may be supplied by supplying a two-component developer having toner and carrier. By supplying a predetermined amount of new carrier during the developing operation, the deteriorated old carrier is gradually replaced by the new carrier. Thereby, the toner charge performance of the developer 51 within the case 50 is maintained uniformly.

On the side of the carrying part 50a, a discharge opening 53 as a developer discharge part is formed. The excessive developer 51 corresponding to the increased amount of the developer 51 within the case 50 due to supply of new carrier is discharged from the discharge opening 53 and collected. Within the case 50, the amount of developer 51 is maintained constant. Concurrently, within the case 50, the deteriorated old carrier of the developer 51 is gradually replaced by new carrier.

The supply part 50b has a supply portion 61 as an opening part for toner supply in a position facing each of the photoconductive drums 12Y, 12M, 12C and 12K. At the supply portion 61, a doctor blade 50c is provided. An air hole feature 62 as a depressurizing part is provided at the downstream of the supply portion 61 in the rotational direction of the developing sleeve 67. At the air hole feature 62, an air filter 63 that collects suspended toner is provided. The air filter 63 is replaceably provided.

In a position facing between the first separating magnetic pole N2 and the second separating magnetic pole N3 at the downstream of the air hole feature 62 in the rotational direction of the developing sleeve 67, a rubber-like magnet 72 is provided on the outer wall of the supply part 50b. The magnetic property of the magnet 72 is 31.0 mT (measured at the center of N-pole surface with thickness magnetization by EMIC), the size of the magnet 72 is, for example, 310 mm in length in the axis direction of the developing roller 58, 5 mm in width, and 1.3 mm in thickness (the thickness including a double-faced tape). The magnet 72 is bonded to the outer wall of the supply part 50b by the double-faced tape.

The developing roller 58 is partially exposed from the supply portion 61. Regarding the developing roller 58, when the developing sleeve 67 rotates in the r direction, the developer 51 forms a magnetic brush 68a around the developing sleeve 67 due to the lines of magnetic force 71 of the magnet roller 68. The supply part 50b supports the developing roller 58 so as to provide a space that does not obstruct the carrying of the magnetic brush 68a between the inner circumference of the supply part 50b and the developing sleeve 67.

The developing sleeve 67 raises the magnetic brush 68a by attracting the developer from the carrying part 50a using the second separating magnetic pole N3 and the supply magnetic pole S2. The height of the magnetic brush 68a is controlled by the doctor blade 50c provided at the supply portion 61. The magnetic brush 68a with the controlled height reaches the developing magnetic pole N1 facing each of the photoconductive drums 12Y, 12M, 12C and 12K. The magnetic brush 68a supplies the developer to each of the photoconductive drums 12Y, 12M, 12C and 12K by the developing magnetic pole N1 and develops the electrostatic latent image for visualization.

After the electrostatic latent image is developed, the magnetic brush 68a is collected into the development container 50 using the collecting magnetic pole S1. The magnetic brush 68a reaches the first separating magnetic pole N2. The magnetic brush 68a forms a blocking brush 73 as a block part between the first separating magnetic pole N2 and the second separating magnetic pole N3.

Between the first separating magnetic pole N2 and the second separating magnetic pole N3, the lines of magnetic force 71 of the magnetic roller 68 reach from the first separating magnetic pole N2 to the magnet 72. The lines of magnetic force 71 are from the magnet 72 toward the developing sleeve 67. The lines of magnetic force 71 reach the second separating magnetic pole N3 along the developing sleeve 67.

By the lines of magnetic force 71 from the magnet 72 toward the developing sleeve 67, the magnetic brush 68a forms the blocking brush 73 between an inner wall of the supply part 50b and the developing sleeve 67. After forming the blocking brush 73, the magnetic brush 68a separates from the developing sleeve 67 while reaching the second separating magnetic pole N3, and is collected in the carrying part 50a.

At the time of image formation, when each of the photoconductive drums 12Y, 12M, 12C and 12K rotates in the direction of the arrow m and the developing sleeve 67 rotates the direction of the arrow r, an air flow α shown by a solid line in FIG. 3 is generated within the case 50. A part α1 of the air flow α directly moves to the air hole feature 62 and is discharged to the outside. The excessive air flow β that is not directly discharged from the air hole feature 62 moves toward inside the supply part 50b. The blocking brush 73 is formed within the supply part 50b. The excessive air flow β collides with the blocking brush 73. The excessive air flow β colliding with the blocking brush 73 does not enter the carrying part 50a but is returned toward the air hole feature 62 and discharged from the air hole feature 62 to the outside. The suspended toner contained in the air flow α1 and air flow β is caught by the air filter 63.

All of the air flow α entering from the supply portion 61 of the case 50 due to rotations of each of the photoconductive drums 12Y, 12M, 12C and 12K and the developing sleeve 67 is discharged from the air hole feature 62 to the outside. The blocking brush 73 blocks the air flow entering the carrying part 50a of the case 50. The internal pressure of the carrying part 50a is not increased and no air flow is ejected from the gap due to the internal pressure of the carrying part 50a. The air flow ejected to the outside and the suspended toner flying to the outside are prevented.

The air filter 63 that catches the suspended toner contained in the air flow α1 and air flow β flowing out from the air hole feature 62 is replaced at maintenance according to how dirty it is, or the number of rotations of the developing roller 58 or the like. At the maintenance of replacement of the air filter 63 or the like, one of the process cartridges 28Y, 28M, 28C and 28K that needs maintenance is detached from the main body of the color printer 1 and the maintenance is done, or one of the process cartridges 28Y, 28M, 28C and 28K is replaced.

In the embodiment, the magnet 72 is provided facing between the first separating magnetic pole N2 and the second separating magnetic pole N3 on the outer wall of the supply part 50b of the case 50. By the rotation of the developing sleeve 67, the first separating magnetic pole N2 and the second separating magnetic pole N3 form the blocking brush 73 between the supply part 50b and the developing sleeve 67 due to the magnetic force of the magnet 72. The blocking brush 73 prevents the excessive air flow β entering from the supply portion 61 and passing through the air hole feature 62 from entering into the carrying part 50a. The air flow β blocked by the blocking brush 73 returns toward the air hole feature 62 and is discharged from the air hole feature 62 to the outside. No air flow is ejected from the clearance due to increase in the internal pressure of the carrying part 50a, the suspended toner is prevented from flying to the outside, and contamination of the surroundings by the suspended toner is prevented.

The invention is not limited to the above embodiment, but various changes can be made within the scope of the invention. For example, the developing device may be used for a monochrome image forming apparatus in which a toner image formed on an image carrier is directly transferred onto a sheet. The image forming apparatus is not limited to a printer, but may be a copier, facsimile, or the like. The number of magnetic poles or the arrangement of magnetic poles of the magnetic roller is not limited as long as the blocking brush can be formed between the developing roller and the development container. For example, a magnetic pole for forming the blocking brush between the developing roller and the development container may separately be provided. If the blocking brush can be formed between the developing roller and the development container, the shape or attachment method of the magnet is not limited. The unit forming the process cartridge is not limited as long as at least the image carrier and the developing device can integrally be attached to or detached from the apparatus main body.

What is claimed is:

1. A developing device comprising:
a development container having a carrying part that carries a developer and a supply part that supplies the developer to an image carrier;
a developing member that is located in the supply part and carries the developer to an opening part of the supply part; and
a block part that is provided between the developing member and the development container at the downstream of the opening part in a rotational direction of the developing member, and blocks an air flow from the supply part into the carrying part.

2. The device according to claim 1, wherein the development container has a depressurizing part between the opening and the block part.

3. The device according to claim 2, wherein the depressurizing part has an air filter.

4. The device according to claim 1, wherein the block part is a blocking brush of the developer formed between a surface of the developing member and the development container.

5. The device according to claim 4, wherein the developing member adjacently has a first magnetic pole and a second magnetic pole having the same polarity as that of the first magnetic pole,
the development container has a magnet at the outside of a position facing between the first magnetic pole and the second magnetic pole, and
the blocking brush is formed by a magnetic force generated by the first magnetic pole, the magnet, and the second magnetic pole.

6. The device according to claim 5, wherein the developing member separates the developer supplied to the image carrier between the first magnetic pole and the second magnetic pole.

7. The device according to claim 5, wherein the magnet is rubber-like magnet.

8. The device according to claim 1, wherein the development container has a developer discharge part that discharges part of the developer.

9. A process cartridge comprising:
an image carrier that supports an electrostatic latent image; and
a developing device that is attached to or detached from an image forming apparatus main body integrally with the image carrier and includes a development container having a carrying part that carries a developer and a supply part that supplies the developer to the image carrier, a developing member that is located in the supply part and carries the developer to an opening part of the supply part, and a block part that is provided between the developing member and the development container at the downstream of the opening part in a rotational direction of the developing member, and blocks an air flow from the supply part into the carrying part.

10. The process cartridge according to claim 9, wherein the development container has a depressurizing part between the opening part and the block part.

11. The process cartridge according to claim 10, wherein the depressurizing part has an air filter.

12. The process cartridge according to claim 9, wherein the block part is a blocking brush of the developer formed between a surface of the developing member and the development container.

13. The process cartridge according to claim 12, wherein the developing member adjacently has a first magnetic pole and a second magnetic pole having the same polarity as that of the first magnetic pole,
the development container has a magnet at the outside of a position facing between the first magnetic pole and the second magnetic pole, and
the blocking brush is formed by a magnetic force generated by the first magnetic pole, the magnet, and the second magnetic pole.

14. The process cartridge according to claim 13, wherein the developing member separates the developer supplied to the image carrier between the first magnetic pole and the second magnetic pole.

15. The process cartridge according to claim 13, wherein the magnet is a rubber-like magnet.

16. The process cartridge according to claim 9, wherein the development container has a developer discharge part that discharges part of the developer.

17. An image forming apparatus comprising:
an image carrier;
a latent image forming part that forms an electrostatic latent image on the image carrier; and
a developing device including a development container having a carrying part that carries a developer and a supply part that supplies the developer to the image carrier, a developing member that is located in the supply part and carries the developer to an opening part of the supply part, and a block part that is provided between the developing member and the development container at the downstream of the opening part in a rotational direction of the developing member, and blocks an air flow from the supply part into the carrying part.

18. The apparatus according to claim 17, wherein the image carrier and the developing device are integrally attached to or detached from an image forming apparatus main body.

19. The apparatus according to claim 17, wherein the development container has a depressurizing part between the opening part and the block part.

20. The apparatus according to claim 19, wherein the block part is a blocking brush of the developer formed between a surface of the developing member and the development container.
